(19) United States
(12) Patent Application Publication
(10) Pub. No.: US 2014/0297836 A1
(43) Pub. Date: Oct. 2, 2014

(54) TRACKING USAGE METRICS FOR A MOBILE APPLICATION

(71) Applicant: LINKEDLN CORPORATION, Mountain View, CA (US)

(72) Inventors: Tomer Cohen, Mountain View, CA (US); Rinaldo A. Jose, San Jose, CA (US)

(73) Assignee: Linkedln Corporation, Mountain View, CA (US)

(21) Appl. No.: 13/856,946

(22) Filed: Apr. 4, 2013

Related U.S. Application Data
(60) Provisional application No. 61/806,750, filed on Mar. 29, 2013.

(51) Int. Cl. H04L 29/08

(52) U.S. Cl. CPC H04L 67/22
USPC 709/224

(57) ABSTRACT

The disclosed embodiments relate to a system for obtaining usage metrics for a mobile application that operates on a mobile computing device. During operation, the system outputs page-specific tracking information when the mobile application loads a page containing user interface elements for the application, wherein loading the page causes the page to be presented to a user of the mobile device. This system also outputs action-specific tracking information when the user performs an action that causes the mobile application to load a page. In some embodiments, outputting the tracking information involves sending the tracking information from the mobile device to a server associated with the mobile application. This enables the server to aggregate the tracking information received from the mobile device along with tracking information received from other mobile devices.

### RELATED APPLICATION

This application hereby claims priority under 35 U.S.C. §119 to U.S. Provisional Application No. 61/806,750, entitled “TRACKING USAGE METRICS FOR A MOBILE APPLICATION,” by inventors Tomer Cohen and Rinaldo A. Jose filed on 29 Mar. 2013 (Atty. Docket No.: LI-P0152.LNK.PROV).

### RELATED ART

The disclosed embodiments generally relate to techniques for gathering information about how users interact with applications. More specifically, the disclosed embodiments relate to techniques for gathering information about how a user accesses a mobile application that operates on a mobile computing device.

### BACKGROUND

As mobile computing devices, such as smartphones and tablet computers, continue to proliferate, they are rapidly becoming the platform of choice for users to access online applications, such as social networking portals. However, users tend to access these online applications differently on mobile devices than on desktop systems. On mobile devices, users typically access online applications through mobile applications that are installed on the mobile devices instead of through websites which are accessed through a browser. This trend is causing online advertisers to change their focus from placing advertisements on pages of popular websites to placing advertisements on pages of popular mobile applications.

Unfortunately, mobile applications presently lack sophisticated tools for gathering statistics about how users actually navigate through pages of mobile applications. This is a problem because advertisers are extremely interested in knowing how often their advertisements located on pages of mobile applications are viewed. Moreover, the providers of such mobile applications are motivated to increase the viewing frequency of pages of these mobile applications. Consequently, they are interested in knowing what causes users to navigate to specific pages of a mobile application.

### BRIEF DESCRIPTION OF THE FIGURES

FIG. 1 illustrates a computing environment in accordance with the disclosed embodiments.

FIG. 2 illustrates a mobile device in accordance with the disclosed embodiments.

FIG. 3A illustrates page-specific and action-specific tracking information in accordance with the disclosed embodiments.

FIG. 3B illustrates an exemplary navigation operation between pages of a mobile application in accordance with the disclosed embodiments.

FIG. 4A presents a flow chart illustrating how the system outputs metrics for a page load operation in accordance with the disclosed embodiments.

FIG. 4B presents a flow chart illustrating how the system outputs metrics for a user action in accordance with the disclosed embodiments.

### DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored on a non-transitory computer-readable storage medium as described above. When a system reads and executes the code and/or data stored on the non-transitory computer-readable storage medium, the system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

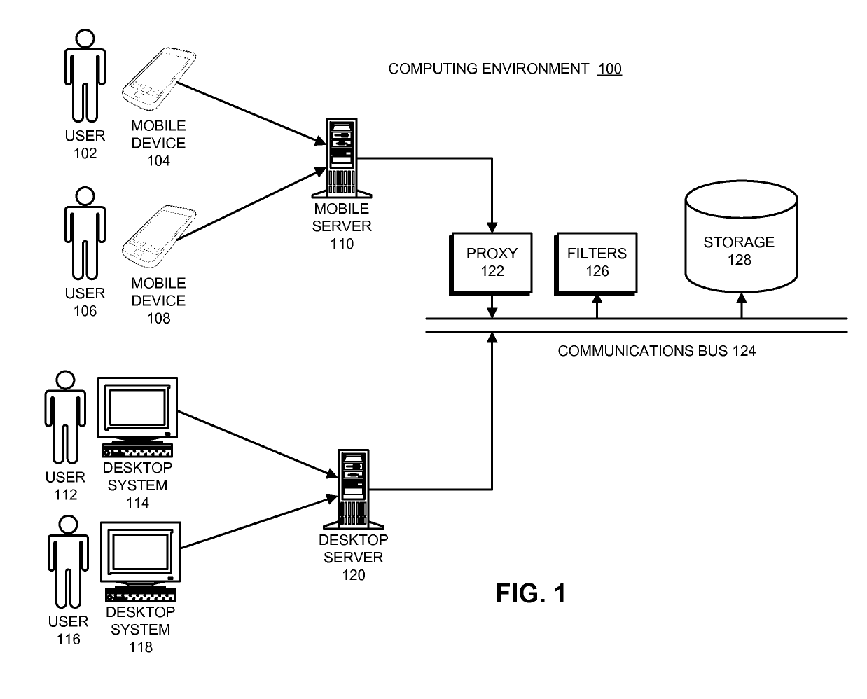

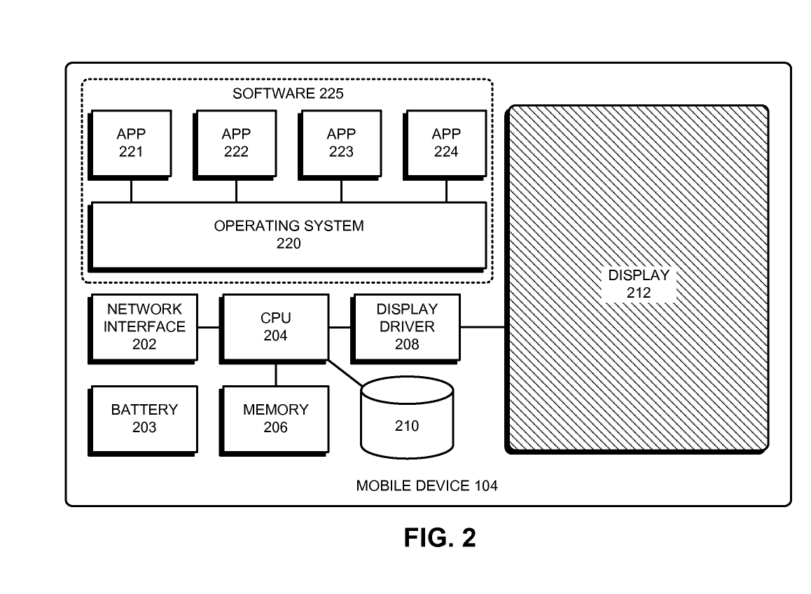

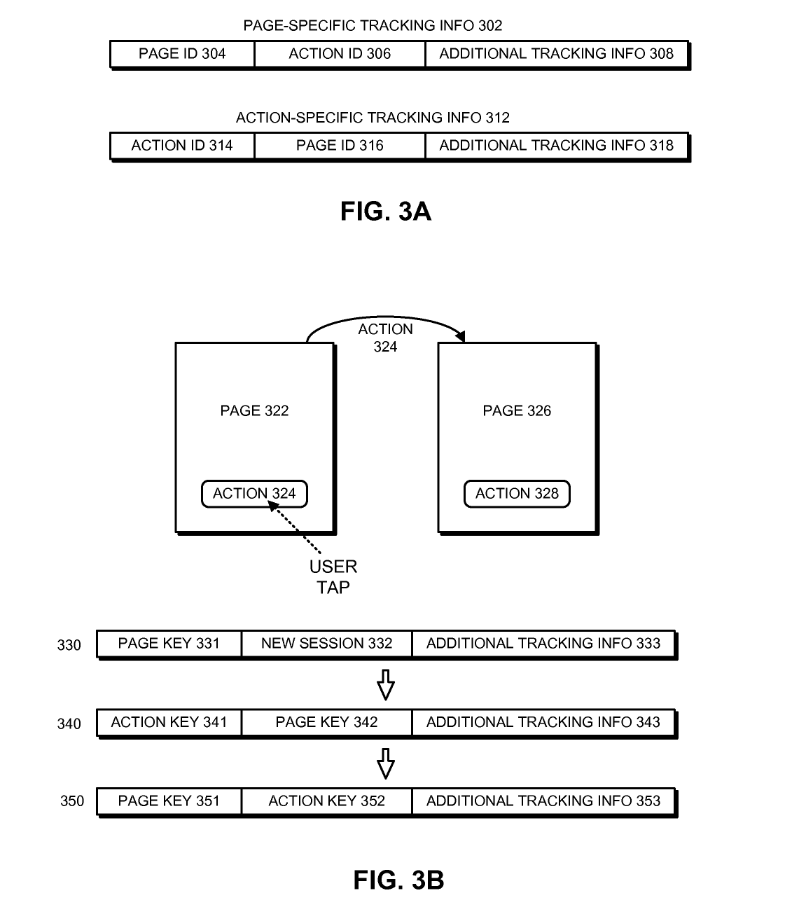

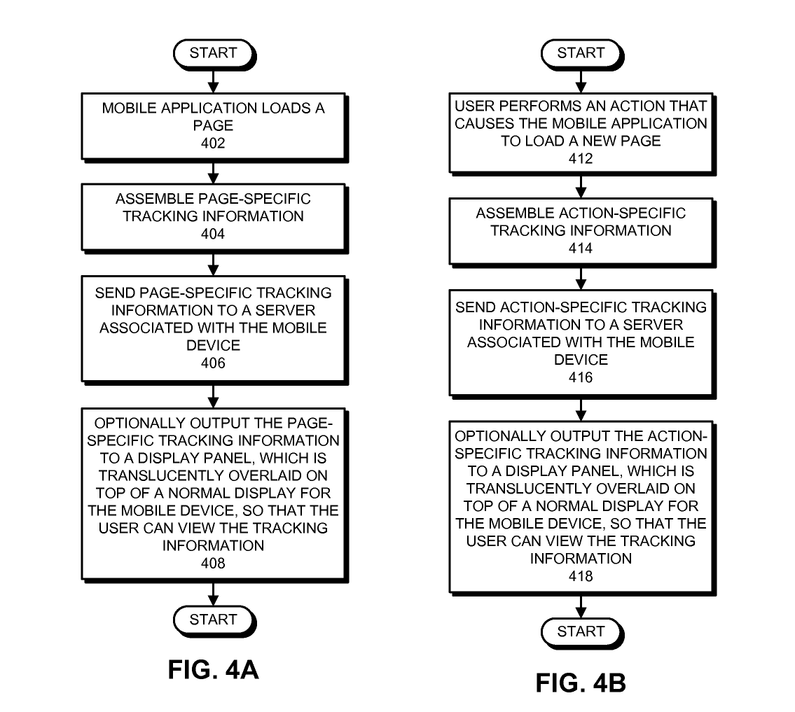

The disclosed embodiments relate to a system that tracks usage metrics for mobile applications. In addition to tracking which pages of a mobile application the user navigates to, the system also keeps track of which actions the user performed to load each page. The system can additionally keep track of other information, such as the operating system version number and the model number for the mobile device. In general, the system can track any type of information that providers of an online application and associated advertisers might be interested in tracking The operation of this system is described in more detail below with reference to FIGS. 3A-4B. However, before describing the details of the system, we first describe details of the computing environment and associated mobile device with reference to FIGS. 1 and 2.

Note that a “page” of an application can include a potion of a user interface for the application comprising a screen or a portion of a screen on a display. A page can contain content, such as images or text. A page can also contain other types of user interface elements, which can be manipulated by a user, such as data entry fields, buttons, sliders or tap-sensitive regions of the display. Note that a page can be larger than what is displayed on a corresponding portion of a screen that is dedicated to the page (e.g., a “window”), in which case the user can perform a scrolling operation with the window to view portions of the page that are not presently visible in the window.

### Computing Environment

FIG. 1 illustrates a computing environment 100 in accordance with the disclosed embodiments. Computing environment 100 includes a system that gathers usage metrics for mobile applications that enable users to access an online application through mobile devices 104 and 108. In some embodiments, the system also gathers usage metrics for browsers on desktop systems 114 and 118 that access a website corresponding to the online application.

More specifically, mobile devices 104 and 108, which are operated by users 102 and 106 respectively, execute mobile applications that serve as access points for an online application, which is hosted on mobile server 110. Note that mobile devices 104 and 108 can generally include any type of portable electronic device that can host a mobile application, such as a smartphone, a tablet computer, a network-connected music player, a gaming console and possibly a laptop computer system.

Mobile devices 104 and 108 can communicate with mobile server 110 through one or more networks (not shown), such as a WiFi network, a Bluetooth™ network or a cellular data network. In some embodiments, during operation, the mobile applications send various types of usage metrics (which are described in more detail below) to mobile server 110. As illustrated in FIG. 1, in some embodiments, mobile server 110 forwards this usage information through a proxy 122 onto a communications bus 124. This usage information is ultimately stored in storage system 128. In some embodiments, the usage information can also be processed using various filters 126 to detect certain types of page views or actions, or associated patterns of page views or actions. Although FIG. 1 illustrates two mobile devices 104 and 108, in general there can be a large number of mobile devices and associated mobile application instances (possibly thousands or millions) that simultaneously send usage information through communications bus 124 to storage system 128.

In some embodiments, this usage information is sent to mobile server 110 as soon as it is generated by mobile devices 104 and 108. Alternatively, in other embodiments, the usage information is aggregated on mobile devices 104 and 108 and can be sent periodically to mobile server 110 in larger blocks.

In some embodiments, desktop systems 114 and 118, which are operated by users 112 and 116 respectively, can periodically transmit usage metrics to desktop server 120. Desktop server 120 can subsequently forward this usage information to communications bus 124. This usage information from desktop systems 114 and 118 can similarly be stored in storage device 128 and can also be processed by filters 126.

In some embodiments, desktop server 120 hosts a website, which is accessed through browsers on desktop systems 114 and 118. In these embodiments, the website can possibly gather the usage metrics instead of relying on code within desktop systems 114 and 118 to gather the usage information. Note that the website located can keep track of how a specific user navigates through the website. However, the website, which is hosted on desktop server 120, may not be able to readily access some types of tracking information, such as the operating system or associated model numbers for desktop systems 114 and 118.

In some embodiments, communications bus 124, proxy 122, filters 126 and storage device 128 can be located on one or more servers distributed access a network. Alternatively, mobile server 110, desktop server 120, proxy 122, communications bus 124, filters 126 and storage device 128 can be hosted on a virtualized cloud-computing system.

### Mobile Device

FIG. 2 illustrates the internal structure of a mobile device 104 in accordance with the disclosed embodiments. In some embodiments, mobile device 104 includes a number of hardware components, including a network interface 202, a battery 203, a central-processing unit (CPU) 204, a memory 206, a non-volatile storage device 210, display driver circuitry 208 and a display 212. Network interface 202 can include any type of circuitry for interfacing with a network, such as a WiFi network, a 3G or 4G data network, a Bluetooth™ network, or generally any type of wireless or wired communication network. Battery 203 can generally include any type of rechargeable (or non-rechargeable battery) that is used to power mobile device 104. CPU 204 can generally include any type of single-core or multi-core processing engine. Memory 206 can generally include any type of random-access memory that can store code and data to be used or manipulated by CPU 204. Display driver circuitry 208 can generally include any type of graphics-processing and amplification circuitry for driving display 212. Finally, display 212 can include any type of display that can be incorporated into mobile device 104, such as the touchscreen (or non-touchscreen) display for a smartphone or a tablet computer.

In some embodiments, mobile device 104 also includes various software components 225, including an operating system 220, which can be used to execute various mobile applications 221-224. Some of these mobile applications can output various types of tracking information as is described in more detail below. For example, the operating system can include the Andriod™ operating system distributed by Google, Inc. of Mountain View, Calif., or alternatively the IOS™ operating system distributed by Apple Inc. of Cupertino, Calif. Moreover, mobile applications 221-224 can include mobile applications which can execute on the Andriod™ or IOS™ operating systems. During operation, at least one of mobile applications 221-224 can output tracking information as is described in more detail below with reference to FIGS. 3A-4B.

### Tracking Information

FIG. 3A illustrates both page-specific tracking information 302 and action-specific tracking information 312 in accordance with the disclosed embodiments. In some embodiments, usage-specific tracking information 302 is outputted whenever a page is loaded during execution of the mobile application. This page-loading operation can include: refreshing a page; loading a new page; returning to a previously accessed page; or crossing a window boundary when scrolling through a large page. As illustrated in FIG. 3A, page-specific tracking information 302 can include an identifier for a page 304, which can be a numeric value such as a sequence number for the page or a link to the page. It can also include an identifier for an action 306 that caused the page to be loaded. For example, the action can include tapping, pulling, scrolling or swiping a location associated with a page. In some embodiments, action 306 can also specify the page where the action took place.

In some embodiments, usage-specific tracking information 302 includes additional tracking information 308. This additional tracking information 308 can include: a version number for the mobile application; a model number for the mobile device; an operating system and associated version number; a session identifier; an identifier for a carrier associated with the mobile device; a timestamp; an orientation of the mobile device, which can include portrait or landscape; a language setting associated with the mobile application or the mobile device; position information for a user interface element associated with the mobile application; and color information for a user interface element associated with the mobile application.

Note that the above-listed types of additional tracking information 308 (such as the color information for the UI) are merely examples of the possible types of tracking information we can pass-through the metric. In general, a user can pass as many fields as needed. For example, in one embodiment of the system, the first 10 fields in additional tracking information 308 are predefined fields, and field 11 and onward can be changed or set arbitrarily to track whatever the user is interested in looking at. For example, for profile pages, the additional tracking information 308 can specify whether the associated profile is a 1^{st}-degree or 2^{nd}-degree connection of the user.

In some embodiments, action-specific tracking information 312 is outputted whenever a user performs an action, such as tapping on a button on a page. In some embodiments, action-specific tracking information 312 includes an identifier for the action 314, which for example can be a numeric value or a character string that identifies the action. It also includes an identifier for a page or widget 316 where the action took place. (Note that a widget is a user interface element associated with the mobile application that is not a page of the mobile application.) In some embodiments, action-specific tracking information 312 also includes additional tracking information 318, which can be similar to additional tracking information 308 described above.

### Exemplary Navigation Operation

FIG. 3B illustrates an exemplary navigation operation between pages of a mobile application in accordance with the disclosed embodiments. In the beginning of the example, page 322 loads because a user has opened the associated mobile application, and page 322 is the initial page of the mobile application. In response to this initial page load, the system outputs page-specific tracking information 330, which includes a page key 331 that identifies the start page of the mobile application. It also includes a new session indicator 332, which signifies that the page load was triggered by the launch of the mobile application. It also includes additional tracking information 333, which for example can identify the version of the mobile application and the associated operating system.

Next, the user taps a button for action 324 (which is indicated by the dashed arrow in FIG. 3B). This causes action 324 to be fired, which causes page 326 to be loaded, wherein page 326 includes a button for another action 328. When action 324 fires, the system outputs action-specific tracking information 340, which includes an action key 341 that identifies the action (user tapping action 324 button on page 322). It also includes a page key 342, which identifies the page on which the action took place, namely page 322. The action-specific tracking information 340 can also include additional tracking information 343, which for example may indicate that 3 seconds elapsed between when page 322 was opened and when the user tapped the button for action 324.

After page 326 eventually loads in response to action 324, the system outputs page-specific tracking information 350, which includes a page key 351 that indentifies page 326. In some embodiments, it also includes an action key 352, which indicates that action 324 caused page 326 to be loaded. Page-specific tracking information 350 also includes additional tracking information 353, which for example can indicate the location and color of the button on page 322 that was pressed to trigger action 324.

### Metrics for a Pane Load

FIG. 4A presents a flow chart illustrating how the system outputs metrics for a page load operation in accordance with the disclosed embodiments. In some embodiments, at the start of the process, the mobile application loads a page (step 402). As mentioned previously, this page load operation can possibly involve refreshing a page; loading a new page; returning to a previously accessed page; and crossing a window boundary while scrolling through a large page. In response to this page load operation, the system assembles the page-specific tracking information as is described with reference to FIG. 3A (step 404.) Next, the system sends the page-specific tracking information to a server associated with the mobile device (step 406). In some embodiments, in a special mode, the system can also output the page-specific tracking information to a display panel, which is translucently overlaid on top of the normal display for the mobile device, so that the user can also view the tracking information (step 408). This allows the user of the mobile application to troubleshoot the system that provides the usage information.

### Metrics for a User Action

FIG. 4B presents a flow chart illustrating how the system outputs metrics for a user action in accordance with the disclosed embodiments. At the start of the process, the user performs an action that causes the mobile application to load a page (step 412). (For example, the user can tap a button.) In response to this action, the system assembles the action-specific tracking information described with reference to FIG. 3A (step 414). Next, the system sends the action-specific tracking information to a server associated with the mobile device (step 416). In some embodiments, in a special mode, the system can also output the action-specific tracking information to a display panel, which is translucently overlaid on top of the normal display for the mobile device, so that the user can also view the tracking information (step 418).

### Scrolling

In some situations, a user scrolls through a very large page which contains a lot of content and periodically stops at different locations in the page to look at content items or to perform actions. In these situations, it does not make sense to count the long scrolling operation with multiple pauses as a single page view. One way to account for such scrolling operations is to divide a large page into multiple “windows,” and then output page-specific tracking information whenever the scrolling crosses a window boundary and pauses at a location on the page.

The foregoing descriptions of disclosed embodiments have been presented only for purposes of illustration and description. They are not intended to be exhaustive or to limit the disclosed embodiments to the forms disclosed. Accordingly, many modifications and variations will be apparent to practitioners skilled in the art. Additionally, the above disclosure is not intended to limit the disclosed embodiments. The scope of the disclosed embodiments is defined by the appended claims.

What is claimed is:

1. A computer-implemented method for obtaining usage metrics for a mobile application that operates on a mobile device, the method comprising:
outputting page-specific tracking information when the mobile application loads a page containing user interface elements for the application, wherein loading the page causes the page to be presented to a user of the mobile device; and
outputting action-specific tracking information when the user performs an action that causes the mobile application to load a page.

2. The computer-implemented method of claim 1, wherein outputting the tracking information, which includes the action-specific tracking information and page-specific tracking information, comprises sending the tracking information from the mobile device to a server associated with the mobile application.

3. The computer-implemented method of claim 2, wherein the method further comprises aggregating the tracking information from the mobile device along with tracking information from other mobile devices at the server.

4. The computer-implemented method of claim 1, wherein the page-specific tracking information includes:
an identifier for the page;
an identifier for an action that caused the page to be loaded; and
additional tracking information.

5. The computer-implemented method of claim 4, wherein the additional tracking information can include:
a version number for the mobile application;
a model number for the mobile device;
an operating system and associated version number;
a session identifier;
an identifier for a carrier associated with the mobile device;
a timestamp;
an orientation of the mobile device, which can include portrait or landscape;
a language setting associated with the mobile application or the mobile device;
position information for a user interface element associated with the mobile application; and
color information for a user interface element associated with the mobile application.

6. The computer-implemented method of claim 1, wherein the action-specific tracking information includes:
an identifier for the action;
an identifier for a page or widget where the action took place, wherein the widget is a user interface element associated with the mobile application that is not a page of the mobile application; and
additional tracking information.

7. The computer-implemented method of claim 1, wherein when the mobile application is operating in a special mode, outputting the tracking information involves additionally outputting the tracking information to a display panel, which is translucently overlaid on top of a normal display for the mobile device, so that the user can view the tracking information.

8. The computer-implemented method of claim 1, wherein when a user is scrolling through a large page, which is divided into multiple windows, the method further comprises outputting page-specific tracking information after the scrolling crosses a window boundary.

9. The computer-implemented method of claim 1, wherein the action can include tapping, pulling, scrolling or swiping a location or a user interface element associated with a page of the mobile application.

10. The computer-implemented method of claim 1, wherein loading the page can include:
refreshing a page;
loading a new page;
returning to a previously accessed page; and
crossing a window boundary while scrolling through a large page.

11. A non-transitory computer-readable storage medium storing instructions that when executed by a computer cause the computer to perform a method for obtaining usage metrics for a mobile application that operates on a mobile device, the method comprising:
outputting page-specific tracking information when the mobile application loads a page containing user interface elements for the application, wherein loading the page causes the page to be presented to a user of the mobile device; and
outputting action-specific tracking information when the user performs an action that causes the mobile application to load a page.

12. The non-transitory computer-readable storage medium of claim 11, wherein outputting the tracking information, which includes the action-specific tracking information and page-specific tracking information, comprises sending the tracking information from the mobile device to a server associated with the mobile application.

13. The non-transitory computer-readable storage medium of claim 11, wherein the page-specific tracking information includes:
an identifier for the page;
an identifier for an action that caused the page to be loaded; and
additional tracking information.

14. The non-transitory computer-readable storage medium of claim 13, wherein the additional tracking information can include:
a version number for the mobile application;
a model number for the mobile device;
an operating system and associated version number;
a session identifier;
an identifier for a carrier associated with the mobile device;
a timestamp;
an orientation of the mobile device, which can include portrait or landscape;
a language setting associated with the mobile application or the mobile device;
position information for a user interface element associated with the mobile application; and
color information for a user interface element associated with the mobile application.

15. The non-transitory computer-readable storage medium of claim 11, wherein the action-specific tracking information includes:
an identifier for the action;
an identifier for a page or widget where the action took place, wherein the widget is a user interface element associated with the mobile application that is not a page of the mobile application; and
additional tracking information.

16. The non-transitory computer-readable storage medium of claim 11, wherein when the mobile application is operating in a special mode, outputting the tracking information involves additionally outputting the tracking information to a display panel, which is translucently overlaid on top of a normal display for the mobile device, so that the user can view the tracking information.

17. The non-transitory computer-readable storage medium of claim 11, wherein when a user is scrolling through a large page, which is divided into multiple windows, the method further comprises outputting page-specific tracking information after the scrolling crosses a window boundary.

18. A system that obtains usage metrics for a mobile application that operates on a mobile device, comprising: the mobile device which includes a processor and a memory; and
the mobile application which executes on the mobile device;
wherein the mobile application is configured to,
output page-specific tracking information when the mobile application loads a page containing user interface elements for the application, wherein loading the page causes the page to be presented to a user of the mobile device; and
output action-specific tracking information when the user performs an action that causes the mobile application to load a page.

19. The system of claim 18, wherein the page-specific tracking information includes:
an identifier for the page;
an identifier for an action that caused the page to be loaded; and
additional tracking information.

20. The system of claim 19, wherein the additional tracking information can include:
a version number for the mobile application;
a model number for the mobile device;
an operating system and associated version number;
a session identifier;
an identifier for a carrier associated with the mobile device;
a timestamp;
an orientation of the mobile device, which can include portrait or landscape;
a language setting associated with the mobile application or the mobile device;
position information for a user interface element associated with the mobile application; and
color information for a user interface element associated with the mobile application.

21. The system of claim 18, wherein the action-specific tracking information includes:
an identifier for the action;
an identifier for a page or widget where the action took place; and
additional tracking information.

22. The system of claim 18, wherein when the mobile application is operating in a special mode, while outputting the tracking information, the mobile application is additionally configured to output the tracking information to a display panel, which is translucently overlaid on top of a normal display for the mobile device, so that the user can view the tracking information.
